(19) United States
(12) Patent Application Publication
(10) Pub. No.: US 2017/0291792 A1
(43) Pub. Date: Oct. 12, 2017

(54) DESTINATION DISPATCH DYNAMIC TUNING

(71) Applicant: Otis Elevator Company, Farmington, CT (US)

(72) Inventors: Bradley Armand Scoville, Farmington, CT (US); Allen Patenaude, Torrington, CT (US); Jannah A. Stanley, Portland, CT (US)

(21) Appl. No.: 15/092,284

(22) Filed: Apr. 6, 2016

(51) Int. Cl. B66B 1/24; B66B 1/46; B66B 1/34

(52) U.S. Cl. CPC B66B 1/2408; B66B 1/3407; B66B 1/468; B66B 2201/4653; B66B 2201/222

(57) ABSTRACT

A system and a method of assigning an elevator car of an elevator system based on an adjustment parameter are provided. The method includes assigning, using the elevator controller, the elevator car based on the adjustment parameter in response to receiving an elevator call, wherein the adjustment parameter includes at least a person to call ratio, receiving one or more system parameters, and updating the adjustment parameter based on the system parameters.

### TECHNICAL FIELD

The subject matter disclosed herein generally relates to elevator dispatching and, more particularly, to tuning elevator dispatching based upon one or more parameters.

### DESCRIPTION OF RELATED ART

Current elevator systems typically do not accommodate for free-riding passengers who do not actually request an elevator be dispatched but who join in the elevator car upon its arrival. This free-riding causes system delays because elevators are typically dispatched utilizing a fixed people/call factor, meaning the dispatched elevator car may not be able to accommodate all requests assigned to it because the elevator car fills with free-riding passengers.

Accordingly, a dynamic and real-time adjustable system for understanding free-riding passenger loads is desired.

### SUMMARY

According to one embodiment, a method of assigning an elevator car of an elevator system based on an adjustment parameter is provided. The method includes assigning, using the elevator controller, the elevator car based on the adjustment parameter in response to receiving an elevator call, wherein the adjustment parameter includes at least a person to call ratio, receiving one or more system parameters, and updating the adjustment parameter based on the system parameters.

In addition to one or more of the features described above, or as an alternative, further embodiments may include receiving the elevator call from a user using at least one of a kiosk and mobile device.

In addition to one or more of the features described above, or as an alternative, further embodiments may include updating an elevator car capacity parameter based on at least the assigning, using the elevator controller, of the elevator car and the adjustment parameter.

In addition to one or more of the features described above, or as an alternative, further embodiments may include collecting system parameters in the form of sensor data using one or more sensors in an elevator lobby connected to the elevator system, analyzing the sensor data to determine at least an estimated number of people waiting for a called elevator car, and calculating the person to call ratio using the estimated number of people, a number of elevator calls, and analyzed sensor data.

In addition to one or more of the features described above, or as an alternative, further embodiments may include collecting system parameters in the form of sensor data using one or more sensors in the elevator car connected to the elevator system, analyzing the sensor data to determine at least an estimated number of people that have boarded the elevator car, and calculating the person to call ratio using the estimated number of people determined using analyzed sensor data, and a number of elevator calls.

In addition to one or more of the features described above, or as an alternative, further embodiments may include wherein the adjustment parameter is computed based upon previous person to call ratios, average person to call ratio values, and a predicted person to call ratio.

In addition to one or more of the features described above, or as an alternative, further embodiments may include wherein the system parameter includes one or more of elevator system sensor data, usage data, time value, date value, call origination floor information, call destination floor information, previous person to call ratios, average person to call ratio values, and a predicted person to call ratio.

In addition to one or more of the features described above, or as an alternative, further embodiments may include updating the elevator car assignment in real-time based on the updated adjustment parameter.

In addition to one or more of the features described above, or as an alternative, further embodiments may include adjusting a number of elevator calls assigned to an elevator car based on the updated adjustment parameter.

In addition to one or more of the features described above, or as an alternative, further embodiments may include generating and updating an adjustment parameter for each origin/destination floor pair.

According to an embodiment, a system for assigning an elevator car of an elevator system based on an adjustment parameter is provided. The system includes an input device that receives an elevator call from a user, one or more sensors that collect system parameters from at least one of an elevator lobby and elevator cars, and an elevator including an elevator controller with an adjustment parameter that includes at least a person to call ratio, wherein the elevator controller is configured to assign one or more elevator cars based on the adjustment parameter in response to receiving the elevator call, receive the system parameters, and update the adjustment parameter based on the system parameters, and the one or more elevator cars that are configured to travel between floors of a building based on the elevator call and adjustment parameter received from the elevator controller.

In addition to one or more of the features described above, or as an alternative, further embodiments may include wherein the input device is at least one selected from a group consisting of a kiosk, a touch screen panel integrated into a wall, a mobile device, an ambient microphone, and a gesture recognition camera.

In addition to one or more of the features described above, or as an alternative, further embodiments may include wherein the one or more sensors are at least one selected from a group consisting of a video camera mounted in an elevator, a video camera mounted in an elevator lobby, a thermal sensor, an ambient microphone, a weight scale mounted in a floor surface, a mobile device mounted sensor that transmits data to the elevator system, a thermometer, and a gas detector.

According to an embodiment a computer program product for assigning an elevator car of an elevator system based on an adjustment parameter is provided. The computer program product including a computer readable storage medium having program instructions embodied therewith, the program instructions executable by a processor to cause the processor to assign, using the elevator controller, the elevator car based on the adjustment parameter in response to receiving an elevator call, wherein the adjustment parameter includes at least a person to call ratio, receive one or more system parameters, and update the adjustment parameter based on the system parameters.

In addition to one or more of the features described above, or as an alternative, further embodiments may include additional program instructions executable by the processor to cause the processor to, further including update an elevator car capacity parameter based on at least the assigning, using the elevator controller, of the elevator car and the adjustment parameter.

In addition to one or more of the features described above, or as an alternative, further embodiments may include additional program instructions executable by the processor to cause the processor to collect system parameters in the form of sensor data using one or more sensors in an elevator lobby connected to the elevator system, analyze the sensor data to determine at least an estimated number of people waiting for a called elevator car, and calculate the person to call ratio using the estimated number of people, a number of elevator calls, and analyzed sensor data.

In addition to one or more of the features described above, or as an alternative, further embodiments may include additional program instructions executable by the processor to cause the processor to collect system parameters in the form of sensor data using one or more sensors in the elevator car connected to the elevator system, analyze the sensor data to determine at least an estimated number of people that have boarded the elevator car, and calculate the person to call ratio using the estimated number of people determined using analyzed sensor data, and a number of elevator calls.

In addition to one or more of the features described above, or as an alternative, further embodiments may include additional program instructions executable by the processor to cause the processor to update the elevator car assignment in real-time based on the updated adjustment parameter.

In addition to one or more of the features described above, or as an alternative, further embodiments may include additional program instructions executable by the processor to cause the processor to adjust a number of elevator calls assigned to an elevator car based on the updated adjustment parameter.

In addition to one or more of the features described above, or as an alternative, further embodiments may include additional program instructions executable by the processor to cause the processor to generate and updating an adjustment parameter for each origin/destination floor pair.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 depicts an elevator system in accordance with one or more embodiments of the present disclosure;

FIG. 2 depicts a system for assigning an elevator car of an elevator system in accordance with one or more embodiments of the present disclosure;

FIGS. 3A through 3C depict users and a system for assigning an elevator car of an elevator system in accordance with one or more embodiments of the present disclosure;

FIGS. 4A and 4B depict a flow chart for assigning an elevator car of an elevator system in accordance with one or more embodiments of the present disclosure; and

FIG. 5 depicts a flow diagram of a method of assigning an elevator car of an elevator system in accordance with one or more embodiments of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments described herein are directed to a method and system for assigning an elevator car of an elevator system based on an adjustment parameter. The adjustment parameter includes, at least, a person to elevator car ratio. The adjust parameter may include other data than can be used when assigning elevator cars. For example, the adjustment parameter can include or be computed based upon previous person to call ratios, average person to call ratio values, and a predicted person to call ratio. Further, the adjustment parameter may be updated using, or may include, one or more system parameters. A system parameter includes one or more of elevator system sensor data, usage data, time value, date value, call origination floor information, call destination floor information, previous person to call ratios, average person to call ratio values, and a predicted person to call ratio.

According to one or more embodiments, the previous person to call ratio can be a ratio that is defined as being calculated any time before the current person to call ratio. For example, the previous person to call ratio can be defined in terms of a particular passage of time. For example, a previous person to call ratio can be a call ratio from a day ago, a week ago, a year ago, or even longer. Also, according to an embodiment, the previous person to call ratio can be from a few minutes ago or seconds ago. Further, according to an embodiment, the previous person to call ratio can be defined as a person to call ratio associated with a different stage of usage of the elevator system. For example, when users initially request and are waiting for an elevator car, a first person to call ratio can be calculated during this first stage of using an elevator which can be called a waiting stage. Once the elevator car arrives, the users enter the car and the car begins to travel to the users' destination floors. This stage can be called a travel stage. During this travel stage a new second person to call ratio can be calculated and the first person to call ratio from the waiting stage is now categorized as a previous person to call ratio. Further, as users arrive at their destinations others may enter the elevator car. At each of these stages a new person to call ratio can be calculated and the preceding ratio can be stored as a previous person to call ratio.

According to one or more embodiments, average person to call ratio value can be calculated for a particular amount of time. For example, the elevator system can calculate an average person to call ratio for each day for use throughout the next day. According to other embodiments, the time frame can be much larger or much smaller. For example, the average person to call ratio value can be calculated based on a collection of previous person to call ratios that are stored that fall within a window of time that can be a few seconds, minutes, or hours. According to another embodiment, the average person to call ratio value can be calculated for each stage of elevator use. For example, an average person to call ratio value can be determined for a waiting stage when users are waiting on the elevator cars. Further, another average person to call ratio value can be calculated for a travel stage and/or an arrival stage. Further, according to another embodiment, an average person to call ratio may be determined on a user to user basis. For example, for each user who repeatedly uses the elevator, an associated average person to call ratio value can be determined, stored, and used when that user is identified making a future elevator call. Further, according to another embodiment, an average person to call ratio value can be determined and stored for specific elevator origin/destination pairs. For example, an average person to call ratio value can be calculated based on calls and users requesting and traveling from a lobby floor to a third floor were a food court and sky bridges to other buildings are located.

According to one or more embodiments, the predicted person to elevator ratio is defined as a ratio calculated based on a predicated number of people generated using sensor data collected using one or more sensors of the elevator system. For example, an image sensor can collect image data in a lobby and that image data can be processed to provide a predicted count of people in the image data. Based on this predicted value, a predicted person to elevator ratio can be calculated. According to another example, an image sensor can be provided in an elevator car that collects similar image data that can be processed to provide a predicted count of people. According to other embodiments, other sensor types and associated collected data can be used to calculate the predicted count of people. Further, according to another embodiment, the predicted person to elevator ratio can be a forward looking projection ratio value calculated using one or more previous person to call ratios, one or more average person to call ratio value, and/or other stored values or data.

For example, according to one or more embodiments, a system is provided that can detect the number of people in an elevator car and the number of people waiting for an elevator car. In one or more embodiments, the system compares these different numbers to the number of requests and dynamically adjusts the system such that elevator cars are dispatched to address requests made, as well as free-riding passengers who do not make requests but who will utilize the dispatched elevator car.

According to one or more embodiments, the system uses four measurement points: (1) people count of the group waiting to board a specific elevator car (called “Pw”); (2) people count of the number of people who have boarded the elevator car once the doors have closed (called “Pb”); (3) the number of destination requests (called “Pc”); and (4) an inferred measurement of the number of users, namely Pc*(people/call factor)=Pe (expected users). The people/call factor is updated via a feedback loop, which is based on observations collected by a sensor system.

In one or more embodiments, when passengers waiting (Pw) is equal to the maximum assigned users for an elevator cab, a notification is sent to the dispatcher to prevent future allocation of the elevator car. According to one or more embodiments, the system's method to detect the number of people waiting and the number of people in an elevator car, and compare those numbers to the number of requests, allows the dispatcher to respond by (1) eliminating allocation of future requests to a full cab, and (2) updating the people/call factor for future requests such that the expected number of people approaches the actual number of people observed in departing elevator cars. In this way, the system reduces system waste and slow-downs.

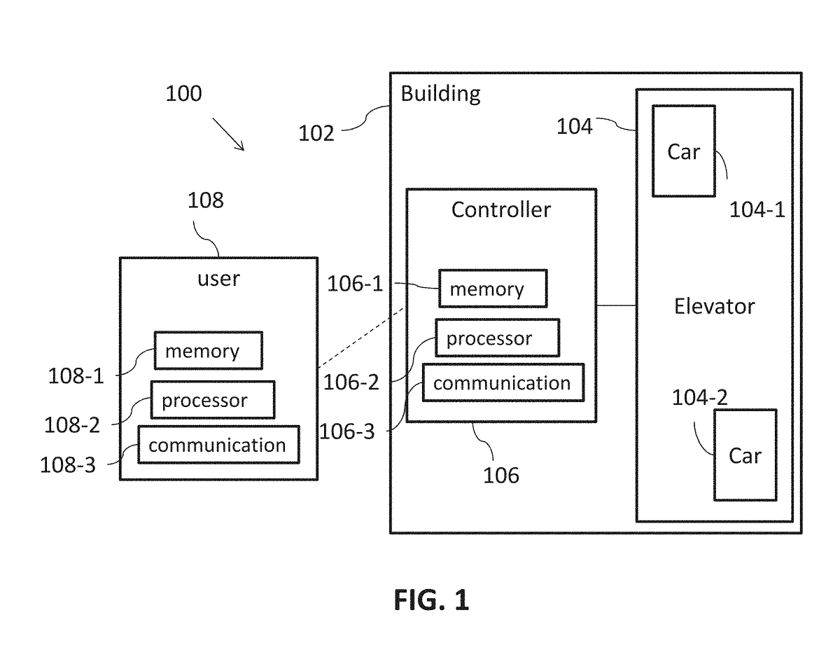

Turning now to the figures, FIG. 1 depicts an elevator system 100 in accordance with one or more embodiments. The elevator system 100 is shown installed at a building 102. In some embodiments, the building 102 may be an office building or a collection of office buildings that may or may not be physically located near each other. The building 102 may include a number of floors. Persons entering the building 102 may enter at a lobby floor, or any other floor, and may go to a destination floor via one or more conveyance devices, such as an elevator 104.

The elevator 104 may be coupled to one or more computing devices, such as a controller 106. The controller 106 may be configured to control dispatching operations for one or more elevator cars (e.g., cars 104-1, 104-2) associated with the elevator 104. The elevator cars 104-1 and 104-2 may be located in the same hoist way or in different hoist ways so as to allow coordination amongst elevator cars in different elevator banks serving different floors. It is understood that other components of the elevator system 100 (e.g., drive, counterweight, safeties, etc.) are not depicted for ease of illustration.

Also shown in FIG. 1 is a mobile device 108. The mobile device 108 may include a device that is typically carried by a person, such as a phone, PDA, electronic wearable, RFID tag, laptop, tablet, watch, or any other known portable mobile device. The mobile device 108 may include a processor 108-2, a memory 108-1, and a communication module 108-3 as shown in FIG. 1. The processor 108-2 can be any type or combination of computer processors, such as a microprocessor, microcontroller, digital signal processor, application specific integrated circuit, programmable logic device, and/or field programmable gate array. The memory 108-1 is an example of a non-transitory computer readable storage medium tangibly embodied in the mobile device 108 including executable instructions stored therein, for instance, as firmware. The communication module 108-3 may implement one or more communication protocols as described in further detail herein.

The controller 106 may include a processor 106-2, a memory 106-1, and communication module 106-3 as shown in FIG. 1. The processor 106-2 can be any type or combination of computer processors, such as a microprocessor, microcontroller, digital signal processor, application specific integrated circuit, programmable logic device, and/or field programmable gate array. The memory 106-1 is an example of a non-transitory computer readable storage medium tangibly embodied in the controller 106 including executable instructions stored therein, for instance, as firmware. The communication module 106-3 may implement one or more communication protocols as described in further detail herein.

The mobile device 108 and the controller 106 communicate with one another. According to one or more embodiments, the communication between the mobile device 108 and the controller 106 is done through other systems such as transmitters, converters, receivers, and other transmitting and processing elements depending on the communication type selected. For example, the mobile device 108 and the controller 106 may communicate with one another when proximate to one another (e.g., within a threshold distance). The mobile device 108 and the controller 106 may communicate over a wireless network, such as 802.11x (WiFi), short-range radio (Bluetooth), or any other known type of wireless communication. In some embodiments, the controller 106 may include, or be associated with (e.g., communicatively coupled to) a networked element, such as kiosk, beacon, hall call fixture, lantern, bridge, router, network node, etc. The networked element may communicate with the mobile device 108 using one or more communication protocols or standards. For example, the networked element may communicate with the mobile device 108 using near field communications (NFC), or any type of known wired or wireless communication means. According to one or more other embodiments, the networked element may communicate with the mobile device 108 through a cellular network or over the internet through a number of other devices outside the building.

In other embodiments, the controller 106 may establish communication with a mobile device 108 that is outside of the building 102. This connection may be established with various technologies including GPS, triangulation, or signal strength detection, by way of non-limiting example. The communication connection that can be established includes, but is not limited to, a cellular connection, a WiFi connection, a Bluetooth connection, a peer-to-peer connection, a satellite connection, a NFC connection, some other wireless connection, and even a wired connection using an Ethernet cable, coaxial cable, or other data cable. These communication connections may transport data between the mobile device 108 using a number of different networks ranging from a private secure direct communication link to transporting the data over the internet through multiple different servers, switches, etc. Such technologies that allow early communication will provide users and the systems more time to establish the most efficient passenger flow, and may eliminate the need for a user to stop moving to interact with the system.

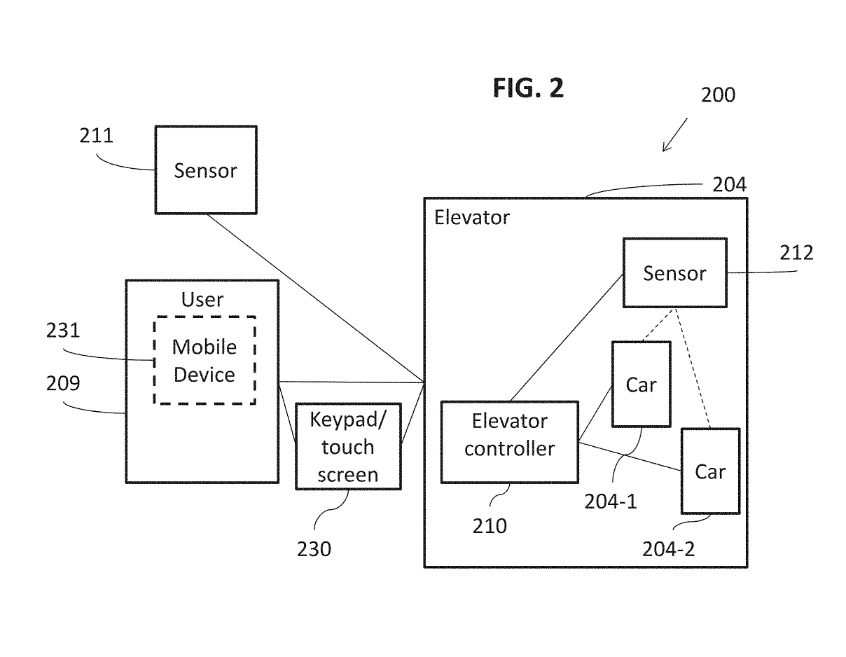

Implementation of a method and system of assigning an elevator car of an elevator system based on an adjustment parameter using one or more of the mobile device, controller, and elevator is described with reference to FIGS. 2-5.

FIG. 2 depicts a system for assigning an elevator car of an elevator system based on an adjustment parameter in accordance with one or more embodiments of the present disclosure. A user (209) may utilize a mobile device (231) to call for an elevator car. In other embodiments, this mobile device may be any mobile device, including but not limited to, a cellular phone, PDA, tablet, or laptop. The call for an elevator car that is placed on the mobile device (231) is received by the elevator (204), which includes an elevator controller (210), multiple elevator cars (204-1, 204-2), and a sensor (212). Further, according to one or more embodiments, the user may call an elevator using a keypad/touch screen. Further, a sensor (211) may detect the presence of a user of make the elevator call on behalf on the user. Further, the user may input a number of people that are traveling along with the user for the one elevator call. This entry may be provided using the mobile device (231) and/or the keypad/touchscreen (230). Further, the sensor (211) can be used to collected data that can be processed and used to predict a number of users. For example the sensor (231) may be a wireless router that counts the number of connected devices and provides that count as a predicted user number. According to another embodiment, the sensor (231) may be any of a number of know sensing devices that use images, sound, video, and other collected data to calculate a number of passengers.

In accordance with one or more embodiments, there are can be many more elevator cars and a plurality of sensors within each elevator (204). Within each elevator system (204), the elevator controller (210) receives and provides inputs to the sensor (212) and dispatches the cars (204-1, 204-2). In some embodiments, the sensor (212) may communicate directly with the elevator cars (204-1, 204-2) as well.

In other embodiments, the user (209) may instead utilize a keypad/touch screen (230) to call for an elevator car. The call for an elevator car that is placed on the keypad/touch screen (230) is received by the elevator (204). Further, in accordance with one or more embodiments, an elevator call can be made using any number of different input mechanisms such as, for example, a security kiosk or some other device where a user swipes a card, provides a finger print or retinal scan, or some other form of ID.

According to one or more embodiments, one or more sensors are used to collected data and calculate a number of passengers at different stages of operation of an elevator system. For example sensors located outside of an elevator car can be used to predict a potential number of people that may board an elevator based on their movement and location and, if they can be identified, the prior usage information. According to another example, sensors inside an elevator car can be used to detect the number of passengers that actually are on the car. In other embodiments, a sensor (211) that may be located in the elevator landing may communicate with the elevator (204) with a variety of parameters and information collected. In some embodiments, the information collected by the sensor (211) and transmitted to the elevator (204) would be utilized by the elevator controller (210) in determining which elevator cars (204-1, 204-2) to dispatch for various call requests and how many cars to dispatch for various call requests.

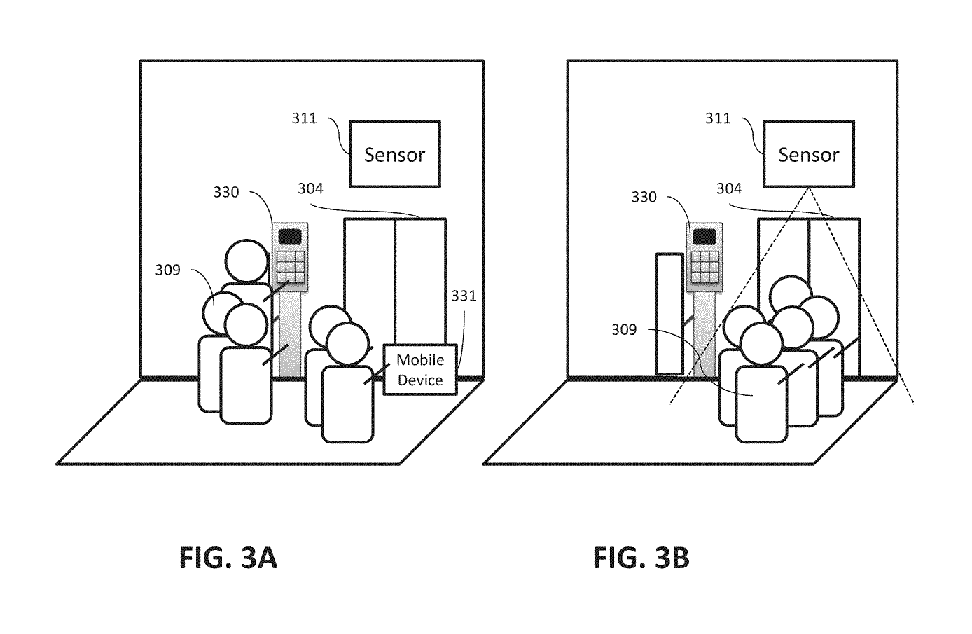

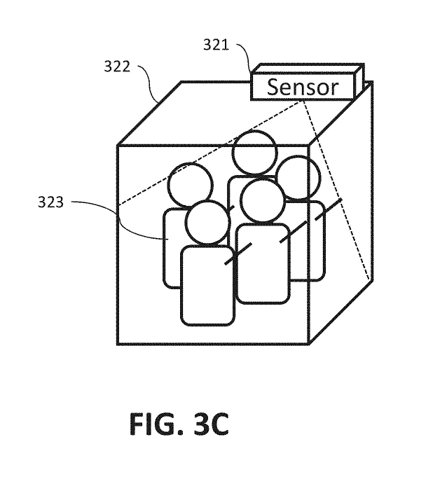

FIGS. 3A through 3C depict users and a system for assigning an elevator car of an elevator system based on an adjustment parameter in accordance with one or more embodiments of the present disclosure. FIG. 3A depicts an elevator landing area with a number of waiting passengers (309). One passenger is utilizing the keypad/touch screen (330) to call an elevator car. On passenger is utilizing their mobile device (331) to call an elevator car. The other passengers are not calling for an elevator car, and instead will be free-riding passengers when a car arrives to the elevator bank (304). There is a sensor (311) located at the elevator landing space, collecting multiple data elements, a described further below.

FIG. 3B depicts the same elevator landing area as that in FIG. 3A, and depicts one way in which an adjustment parameter is collected that is then used by an elevator system to dispatch. The sensor (311) collects information that determines the number of people waiting for the elevator car (Pw), and may do so through a variety of data points, including but not limited to, visual data, weight data, or mobile recognition data. In some embodiments, the information collected by the sensor (311) to determine the “Pw” count may be communicated to the elevator dispatcher so that the dispatcher may update its dispatch plan accordingly. For example, an imagine sensor can collect images which can be processed to determine objects within the image. This can be done by tracking color and patterns to determine an object in the space. Another embodiment of image processing includes processing the collect light frequency, intensity, and direction. According to other embodiments, other image processing techniques for detecting and tracking objects in a space can be implements. Some include using multiple sensors and combining the collected image data to generate matrix image data that can be processed and provide an estimated count of users. Alternatively, completely different types of sensor can be used in conjunction or separate from the image sensors. For example, a microphone or microphone array can collect audio signals and can used voice recognition and directional sound processing techniques to identify a number of unique users within range of the microphone or microphone array.

Further according to another embodiment can use video or 3D depth sensing technology to determine the number of users and track users in a space. According to another embodiment, depth sensing technology can be used to determine the number of users. This method is useful because it is privacy preserving because there is no RGB information. Specifically, each data point in the array provided by the sensor represents a distance of objects in the field of view from the sensor. Using this information the system can classify objects based on number of pixels and track their movement over time frame by frame. Further according to another embodiment, the system may use infrared (IR) thermal detection to determine the number of users. The predict number of passengers can be combined with the number of received elevator calls to generate a people-to-call ratio. The calculated number of passengers detected using sensors can be called an expected passenger value (Pe). This value can be calculated at different location and stages of use of an elevator system. For example the Pe can be calculated in a lobby area or later within the elevator car. The updated value can be used to adjust elevator control and dispatching.

FIG. 3C depicts the inside of an elevator car (322), filled with a number of passengers (323), and depicts a second way in which an adjustment parameter is collected that is then used by an elevator system. Each elevator car is equipped with a sensor (321). The sensor (321) collects information that determines the number of people who boarded the elevator car (Pb), and may do so through a variety of data points, including but not limited to, visual data, weight data, or mobile recognition data. For example, according to one or more embodiments, the sensor (321) may be an image sensor. The image sensor can collect a variety of different frequency light that reflects from objects in the space. The collected light can be in the form of vertical planes of light beams that can be used to count users boarding and un-boarding. Further, according to other embodiments, the imagine sensors can use image processing techniques to detect edges, objects, and then track object movements that can be stored as movement vectors which can be used to predict user counts at different points of elevator usage. The predict number of passengers can be combined with the number of received elevator calls to generate a people-to-call ratio. In some embodiments, the information collected by the sensor (321) to determine the “Pb” count may be communicated to the elevator dispatcher so that the dispatcher may update its dispatch plan accordingly to accommodate for the unexpected free-riding passengers that may bring the elevator car to capacity and impact the elevator car's ability to service other dispatch calls previously assigned.

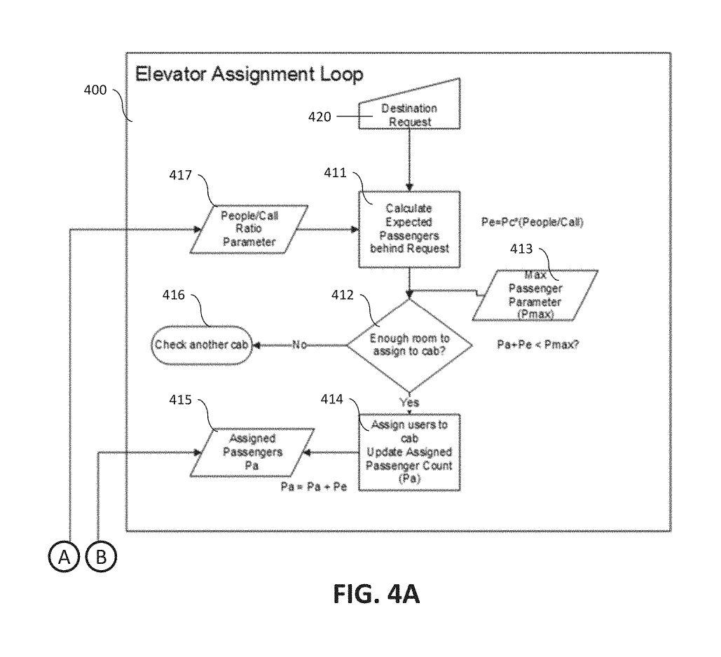

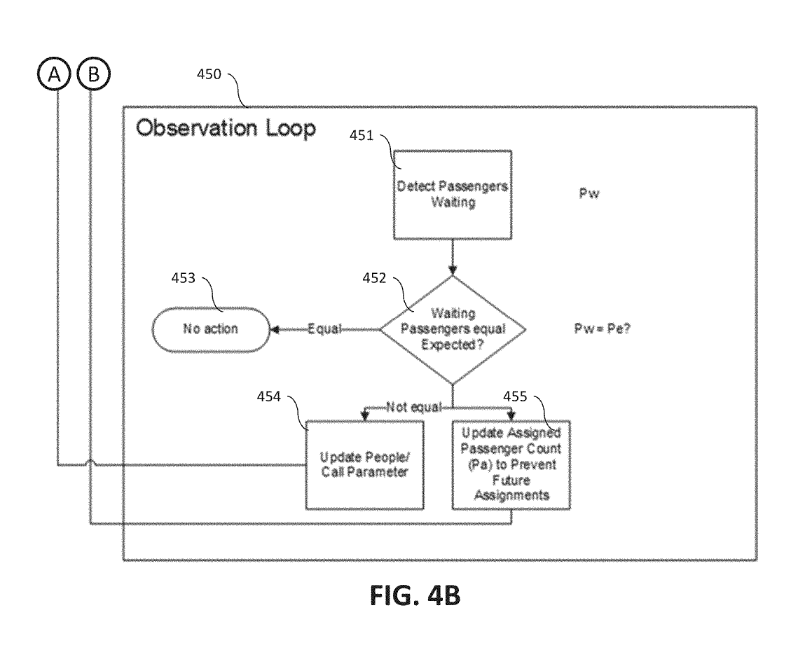

FIGS. 4A and 4B depict a flow chart for assigning an elevator car of an elevator system based on an adjustment parameter in accordance with one or more embodiments of the present disclosure.

Specifically, FIG. 4A shows an elevator assignment loop (400) in accordance with one or more embodiments. As shown, the elevator assignment loop 400 starts with receiving a destination request (Pc) from a passenger (420). This request (420) can come from a user through a mobile device, through a kiosk, or wall mounted button. A people-to-call ratio parameter (People/Call) is provided (417) in the elevator assignment loop (400). The people-to-call ratio is defined as number of people that use an elevator per call made for that particular elevator. According to one or more embodiments, there is some initial state assumed by the system and it is updated through the feedback loop. The people to call ratio parameter (417) may be regularly updated as discussed later in FIG. 4B and discussed above in other embodiments. Next, the elevator assignment loop (400) calculates an expected passenger value (Pe) that is behind the request value (411).

According to one embodiment, the elevator assignment loop (400) also has stored a maximum passenger parameter (Pmax) (413) for each elevator car. This value can be used in conjunction with the calculated expected passenger count to determine if there is enough room in the car/cab to assign the call (420) to the elevator car (412). If there is not enough space, then another elevator car/cab is checked (416). If there is enough room, then the users are assigned to the elevator cab and the assigned passenger count (Pa) is updated (414) to account for the additional users.

Turning now to FIG. 4B, an observation loop (450) is shown which observes and updates values that are used in the above discussed elevator assignment loop (400) in accordance with one or more embodiments. Particularly, the observation loop (450) detects passengers waiting (451) (Pw) in an elevator lobby area as discussed above. The observation loop (450) then compares that detected value Pw to see if it equals the expected passenger value (Pe) (452). However, when they are not equal updating occurs. Particularly, the People/Call parameter is updated to reflect the inequality (454). Specifically, the ratio goes down if less people are expected and up if more. Further, the assigned passenger count (Pa) is updated to prevent future assignments (455). These updated values are transmitted through A and B as shown to the elevator assignment loop (400).

According to one or more embodiments, at any point of operation of the system if it is detected (in the hallway or in car) that there are more users than expected and new dispatching decision will be implemented, then the system notifies users if they need to ride in a different elevator than originally assigned. This can be communicated to users using the elevator fixture displays, or for mobile users this notification can be communicated directly to user mobile devices.

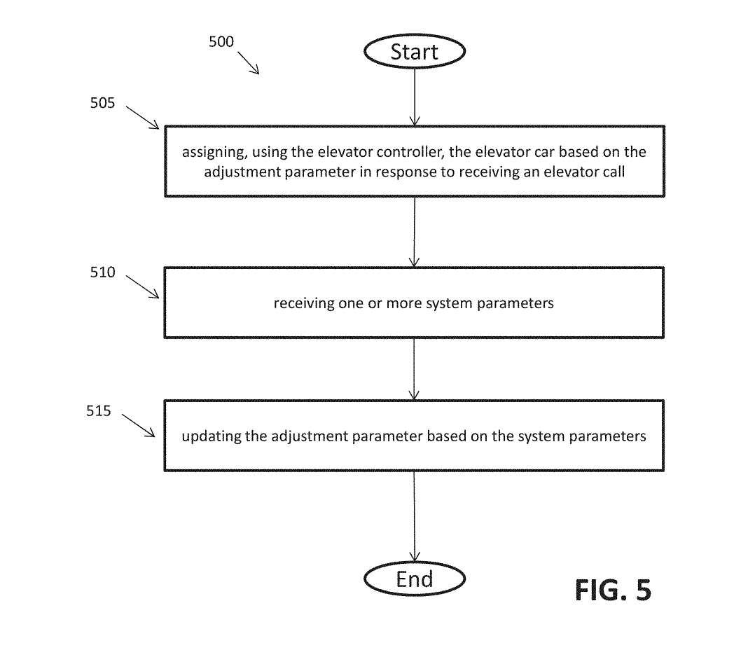

Turning now to FIG. 5, a flow diagram of a method of assigning an elevator car of an elevator system (500) based on an adjustment parameter is shown in accordance with one or more embodiments of the present disclosure. The adjustment parameter can include any of the calculated values discussed above such as Pa, Pe, Pw, as well as other data collected by sensors and processed to help determined the number of passengers. This method includes first assigning, using the elevator controller, the elevator car based on the adjustment parameter in response to receiving an elevator call (operation 505). This method includes next receiving one or more system parameters (operation 510). This method includes lastly updating the adjustment parameter based on the system parameters (operation 515).

According to another embodiment, the method may further include generating and updating an adjustment parameter for each origin/destination floor pair. For example, a first user who arrives at floor 1 and requests floor 10 may be assigned an elevator car based on an adjustment parameter that is specifically generated and updated for that floor pairing. Similarly, a second user exiting the building from floor 10 going down to the lobby on floor 1 may be assigned a car using another adjustment parameter for that origin/destination floor pair. This embodiment provides the ability to adjust for variable traffic patterns based on the origin and destination floors. For example, in the above example, if the first user requests an elevator car from floor 1 to floor 10 at 8:00 am when a large number of people are also arriving to the building, the adjustment parameter for that request can be tailored for that origin to destination. Similarly, if the second user requests to depart from floor 10 to floor 1 at 8:00 am the adjustment parameter used to assign an elevator car can be the one specific to that origin and destination which would likely have less traffic and therefore the adjustment parameter would have a different person to call ratio as well other parameters or data that can be included in the adjustment parameter.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable program instructions may execute entirely on the user's mobile device, partly on the user's mobile device, as a stand-alone software package, partly on the user's mobile device and partly on a remote computer or entirely on the remote computer or server. In the latter scenario, the remote computer may be connected to the user's mobile device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

What is claimed is:

1. A method of assigning an elevator car of an elevator system based on an adjustment parameter, the method comprising:
assigning, using the elevator controller, the elevator car based on the adjustment parameter in response to receiving an elevator call,
wherein the adjustment parameter includes at least a person to call ratio;
receiving one or more system parameters; and
updating the adjustment parameter based on the system parameters.

2. The method of claim 1, further comprising:
receiving the elevator call from a user using at least one of a kiosk and mobile device.

3. The method of claim 1, further comprising:
updating an elevator car capacity parameter based on at least the assigning, using the elevator controller, of the elevator car and the adjustment parameter.

4. The method of claim 1, further comprising:
collecting system parameters in the form of sensor data using one or more sensors in an elevator lobby connected to the elevator system;
analyzing the sensor data to determine at least an estimated number of people waiting for a called elevator car; and
calculating the person to call ratio using the estimated number of people, a number of elevator calls, and analyzed sensor data.

5. The method of claim 1, further comprising:
collecting system parameters in the form of sensor data using one or more sensors in the elevator car connected to the elevator system;
analyzing the sensor data to determine at least an estimated number of people that have boarded the elevator car; and
calculating the person to call ratio using the estimated number of people determined using analyzed sensor data, and a number of elevator calls.

6. The method of claim 1, wherein the adjustment parameter is computed based upon previous person to call ratios, average person to call ratio values, and a predicted person to call ratio.

7. The method of claim 1, wherein the system parameter includes one or more of elevator system sensor data, usage data, time value, date value, call origination floor information, call destination floor information, previous person to call ratios, average person to call ratio values, and a predicted person to call ratio.

8. The method of claim 1, further comprising:
updating the elevator car assignment in real-time based on the updated adjustment parameter.

9. The method of claim 1, further comprising:
adjusting a number of elevator calls assigned to an elevator car based on the updated adjustment parameter.

10. The method of claim 1, further comprising:
generating and updating an adjustment parameter for each origin/destination floor pair.

11. A system for assigning an elevator car of an elevator system based on an adjustment parameter, the system comprising:
an input device that receives an elevator call from a user;
one or more sensors that collect system parameters from at least one of an elevator lobby and elevator cars; and
an elevator comprising:
an elevator controller with an adjustment parameter that includes at least a person to call ratio,
wherein the elevator controller is configured to assign one or more elevator cars based on the adjustment parameter in response to receiving the elevator call, receive the system parameters, and update the adjustment parameter based on the system parameters; and
the one or more elevator cars that are configured to travel between floors of a building based on the elevator call and adjustment parameter received from the elevator controller.

12. The system of claim 11, wherein the input device is at least one selected from a group consisting of a kiosk, a touch screen panel integrated into a wall, a mobile device, an ambient microphone, and a gesture recognition camera.

13. The system of claim 11, wherein the one or more sensors are at least one selected from a group consisting of a video camera mounted in an elevator, a video camera mounted in an elevator lobby, a thermal sensor, an ambient microphone, a weight scale mounted in a floor surface, a mobile device mounted sensor that transmits data to the elevator system, a thermometer, and a gas detector.

14. A computer program product for assigning an elevator car of an elevator system based on an adjustment parameter, the computer program product comprising a computer readable storage medium having program instructions embodied therewith, the program instructions executable by a processor to cause the processor to:
assign, using the elevator controller, the elevator car based on the adjustment parameter in response to receiving an elevator call,
wherein the adjustment parameter includes at least a person to call ratio;
receive one or more system parameters; and
update the adjustment parameter based on the system parameters.

15. The computer program product of claim 14, the computer program product comprising additional program instructions executable by the processor to cause the processor to, further comprising:
update an elevator car capacity parameter based on at least the assigning, using the elevator controller, of the elevator car and the adjustment parameter.

16. The computer program product of claim 14, the computer program product comprising additional program instructions executable by the processor to cause the processor to:
collect system parameters in the form of sensor data using one or more sensors in an elevator lobby connected to the elevator system;
analyze the sensor data to determine at least an estimated number of people waiting for a called elevator car; and
calculate the person to call ratio using the estimated number of people, a number of elevator calls, and analyzed sensor data.

17. The computer program product of claim 14, the computer program product comprising additional program instructions executable by the processor to cause the processor to:
collect system parameters in the form of sensor data using one or more sensors in the elevator car connected to the elevator system;
analyze the sensor data to determine at least an estimated number of people that have boarded the elevator car; and
calculate the person to call ratio using the estimated number of people determined using analyzed sensor data, and a number of elevator calls.

18. The computer program product of claim 14, the computer program product comprising additional program instructions executable by the processor to cause the processor to:
update the elevator car assignment in real-time based on the updated adjustment parameter.

19. The computer program product of claim 14, the computer program product comprising additional program instructions executable by the processor to cause the processor to:
adjust a number of elevator calls assigned to an elevator car based on the updated adjustment parameter.

20. The computer program product of claim 14, the computer program product comprising additional program instructions executable by the processor to cause the processor to:
generate and updating an adjustment parameter for each origin/destination floor pair.
